(19) United States
(12) Patent Application Publication
(10) Pub. No.: US 2013/0159955 A1
(43) Pub. Date: Jun. 20, 2013

(54) DYNAMIC PIN ACCESS MAXIMIZATION FOR MULTI-PATTERNING LITHOGRAPHY

(71) Applicants: Rani Abou Ghaida, Mount Kisco, NY (US); Kanak Behari Agarwal, Austin, TX (US); Lars Wolfgang Liebmann, Poughquag, NY (US); Sani Richard Nassif, Austin, TX (US)

(72) Inventors: Rani Abou Ghaida, Mount Kisco, NY (US); Kanak Behari Agarwal, Austin, TX (US); Lars Wolfgang Liebmann, Poughquag, NY (US); Sani Richard Nassif, Austin, TX (US)

(73) Assignee: International Business Machines Corporation, Armonk, NY (US)

(21) Appl. No.: 13/328,976

(22) Filed: Dec. 16, 2011

(51) Int. Cl. G06F 17/50

(52) U.S. Cl. 716/119

(57) ABSTRACT

A method, system, and computer program product for improving pin access in a design of an integrated circuit (IC) for multi-patterning lithography (MPL) are provided in the illustrative embodiments. A cell is placed in the IC design, the cell including a pin shape configured to connect a pin of the cell to a semi-conductor component in the IC design, the cell including a coloring conflict due to the pin shape and an other shape in the cell each being colored using a first color for fabricating onto a wafer using MPL. A net is routed to the pin shape without resolving the coloring conflict, wherein the routing routes the net using a first segment of the pin shape. The pin shape is modified after routing to resolve the coloring conflict to result in a modified cell.

### BACKGROUND

1. Technical Field

The present invention relates generally to a method, system, and computer program product for designing an integrated circuit. More particularly, the present invention relates to a method, system, and computer program product for dynamic pin access maximization in integrated circuit (IC) design for multi-patterning lithography (MPL).

2. Description of the Related Art

Modern day electronics include components that use integrated circuits. Integrated circuits are electronic circuits formed using Silicon as a substrate and by adding impurities to form solid-state electronic devices, such as transistors, diodes, and resistors. Commonly known as a “chip,” an integrated circuit is generally encased in hard plastic. The components in modern day electronics generally appear to be rectangular black plastic pellets with connector pins protruding from the plastic encasement.

Logical synthesis, physical synthesis, and generation of a routed and timing-closed design are some of the functions of an IC design software tool. The software tools used for designing ICs produce, manipulate, or otherwise work with the circuit layout at very small scales. Some of the components that such a tool may manipulate may only measure tens of nanometer across when formed in Silicon. The designs produced and manipulated using these software tools are complex, often including millions of such components interconnected to form an intended electronic circuitry. An interconnected group of components is called a net.

A cell is an actual logic component, such as a semiconductor gate. An IC design software tool can, among other functions, manipulate cells, or interconnect components of one cell with components of other cells, such as to form nets.

Once a design layout (layout) has been finalized for an IC, the design is converted into a set of masks or reticles. A set of masks or reticles is one or more masks or reticles. During manufacturing, a semiconductor wafer is exposed to light or radiation through a mask to form microscopic components of the IC. This process is known as photolithography (lithography).

### SUMMARY

The illustrative embodiments provide a method, system, and computer program product for improving pin access in a design of an integrated circuit (IC) for multi-patterning lithography (MPL). An embodiment places a cell in the IC design, the cell including a pin shape configured to connect a pin of the cell to a semi-conductor component in the IC design, the cell including a coloring conflict due to the pin shape and an other shape in the cell each being colored using a first color for fabricating onto a wafer using MPL. The embodiment routes a net to the pin shape without resolving the coloring conflict, wherein the routing routes the net using a first segment of the pin shape. The embodiment modifies the pin shape after routing to resolve the coloring conflict to result in a modified cell.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of an example double-patterned cell including a pin shape with a coloring conflict, in which pin access can be dynamically maximized using an illustrative embodiment;

FIG. 4 depicts a block diagram of maximized pin access with coloring conflict resolution in accordance with an illustrative embodiment;

FIG. 5 depicts a block diagram of maximizing pin access after routing in accordance with an illustrative embodiment;

FIG. 6 depicts a flowchart of a process of dynamically maximizing pin shape for MPL in accordance with an illustrative embodiment; and

FIG. 7 depicts a flowchart of another process of dynamically maximizing pin shape for MPL in accordance with an illustrative embodiment.

### DETAILED DESCRIPTION

The IC designs are becoming increasingly complex, the number of components per design is increasing, and the size of components being printed is shrinking. The IC design process is being geared for producing components where the size of the components and inter-component spacing are fifteen (15) nanometer (nm) or less across. To give some perspective on the size of the components, the wavelength of the light used for lithography is approximately one hundred and ninety three (193) nm.

Multi-patterning lithography is a method to print sub-resolution features, such as those for the fifteen nm and smaller design technology, where a single mask is not sufficient to guarantee the printability of the design. MPL uses multiple separate patterning processes, where each pattering step prints coarser patterns which are then combined to form the original single finer pattern. Generally in MPL, the target design layout is decomposed into multiple separate targets subject to minimum spacing constraints that can be resolved by the lithography system in single exposure. MPL layout decomposition is also referred to as coloring where different shapes in the original target are colored in different colors with the total number of available colors determined by the number of exposures in MPL. The set of shapes receiving same color after decomposition form a target pattern and represent one exposure of MPL. In so dividing the shapes in the design layout into different colors, the colored masks become more printable as the shapes of the same color form only a part of the cell and are much farther apart as compared to when all the shapes are printed simultaneously.

Double patterning lithography (DPL) is a variation of MPL where layout is colored using two colors. For example, the components or shapes in a layout that may be colored red are printed in one iteration of double patterning lithography, and the components or shapes in the layout that may be colored green are printed in another iteration of double patterning lithography. A shape can be broken up such that a part of the shape is of one color, and another part of the shape is of another color. This process is known as “stitching”. A shape colored in this manner is split into two masks and the patterns from the two masks are connected together through mask overlapping.

The embodiments are described herein using DPL examples only for the clarity of the disclosure and not as a limitation on the embodiments. A problem recognized by an embodiment in presently available DPL technology is also recognized by the embodiments in the presently available MPL technology. Using this disclosure, an embodiment can be implemented in a DPL implementation as well as in an MPL implementation within the scope of the embodiments.

In a cell based design, an intra-cell coloring problem is a problem where shapes or parts thereof in a cell cannot be colored in different colors without violating a minimum distance restriction for distance between same colored shapes. The minimum distance restriction arises due to limitations of the lithography technology used to fabricate the shapes onto a wafer.

Suppose that a cell has shapes A, B, and C. Shapes A, B, and C are so situated in the cell that the distances between A and B, B and C, and C and A, are each less than a minimum distance restriction. Accordingly, A and B have to be colored differently, B and C have to be colored differently, and C and A, have to be colored differently. In a DPL coloring scheme, this configuration poses a coloring problem, also known as a coloring conflict. For example, if A is colored red then B has to be colored a different color, for example, green. But if B is green, then C has to be colored red, which then conflicts with A of the same color, resulting in the coloring conflict.

To help resolve inter-cell coloring conflicts, a standard cell library includes several coloring options for the same cell. For example, a cell library may include two or more versions of the same cell where the different versions of the cell are colored differently. A designer encountering a coloring conflict within a cell can re-design the cell such that the redesigned cell has no conflicts.

A pin shape is a shape in a cell that is to be fabricated. A pin shape represents an input or output port of the cell that can be connected to one or more components in the IC through a process known as routing.

As with any other shape to be fabricated using DPL, pin shapes or parts thereof (segments) can also be colored differently to satisfy a minimum distance restriction. Consequently, pin shapes or parts thereof can also cause coloring conflicts as described earlier.

A pin of a cell may contain one or more redundant shape segments. Presently, when a cell has a coloring conflict involving a pin shape with redundant segments, the pin shape is reduced in a way that the redundant conflicting segment of the pin shape is eliminated, thereby eliminating the coloring conflict. The modified colored cell having the reduced pin shape area at the site of the conflict does not have coloring conflicts. The conflict free cell is then stored in the cell library for later use in routing. A segment of a shape is a part of the shape.

The illustrative embodiments recognize that generally, the larger the pin shape, the more alternatives a router has to route a net to connect to the pin shape. The illustrative embodiments also recognize that trimming a conflicting segment of the pin shape or otherwise modifying the pin shape to reduce the pin shape area to avoid coloring conflicts prior to routing limits the routing options due to reduced pin access options for the cell.

The illustrative embodiments used to describe the invention generally address and solve the above-described problems and other problems related to resolving coloring conflicts involving pin shapes for DPL and MPL. The illustrative embodiments provide a method, system, and computer program product dynamic pin access maximization in IC design for MPL.

An embodiment allows the cell including the conflicting pin shapes to be used for routing. Depending upon the segment of the pins that the router selects for routing, the pin segments are trimmed, moved, changed, or otherwise manipulated to form a modified cell. The modified cell is then used to replace the cell used for routing. Operating in this manner, an embodiment allows a router full flexibility of choosing from amongst all the segments of the pin shape, and then resolving the coloring conflict by manipulating the other segments of the conflicting pin shape.

In case the router selects the conflicting segments for routing, an embodiment resolves the conflict by manipulating the pin shape and re-routes using the modified pin shape's segment. Thus, an embodiment facilitates retaining maximum routing flexibility using the original larger pin shapes, and manipulates the pin shapes to resolve coloring conflicts only as needed after a routing solution (dynamically).

While some embodiments are described with respect to DPL, an implementation may use an embodiment with respect to any number of patterns in MPL without departing the scope of the invention. For example, an implementation may maximize pin access using three or four color patterned cells in the manner of an embodiment without departing the scope of the invention.

The illustrative embodiments are described with respect to certain ICs or circuits only as examples. Such descriptions are not intended to be limiting on the invention. For example, an illustrative embodiment can be implemented with respect to a microprocessor design or a design of a memory in a similar manner within the scope of the illustrative embodiments.

The illustrative embodiments are described with respect to certain data, data structures, file-systems, file names, directories, and paths only as examples. Such descriptions are not intended to be limiting on the invention. For example, an illustrative embodiment described with respect to a local application name and path can be implemented as an application on a remote path within the scope of the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

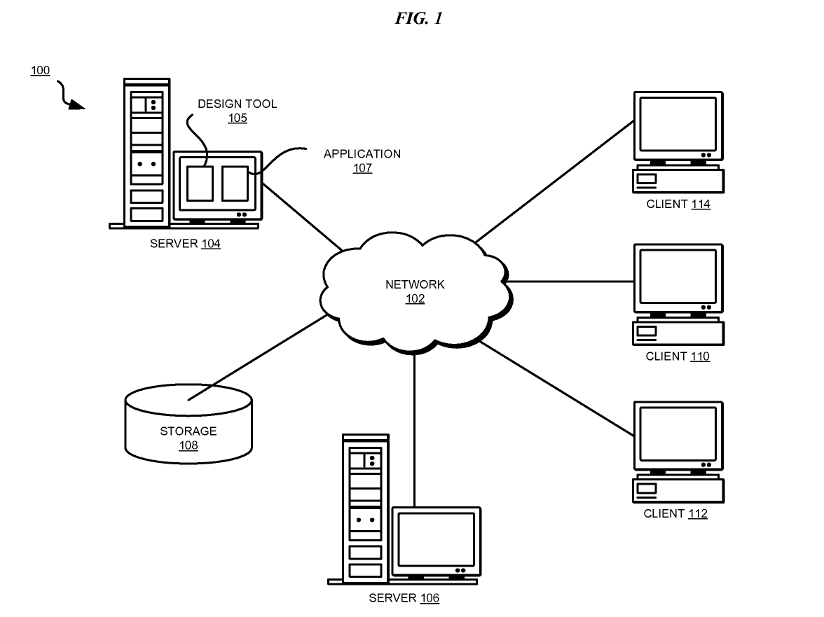

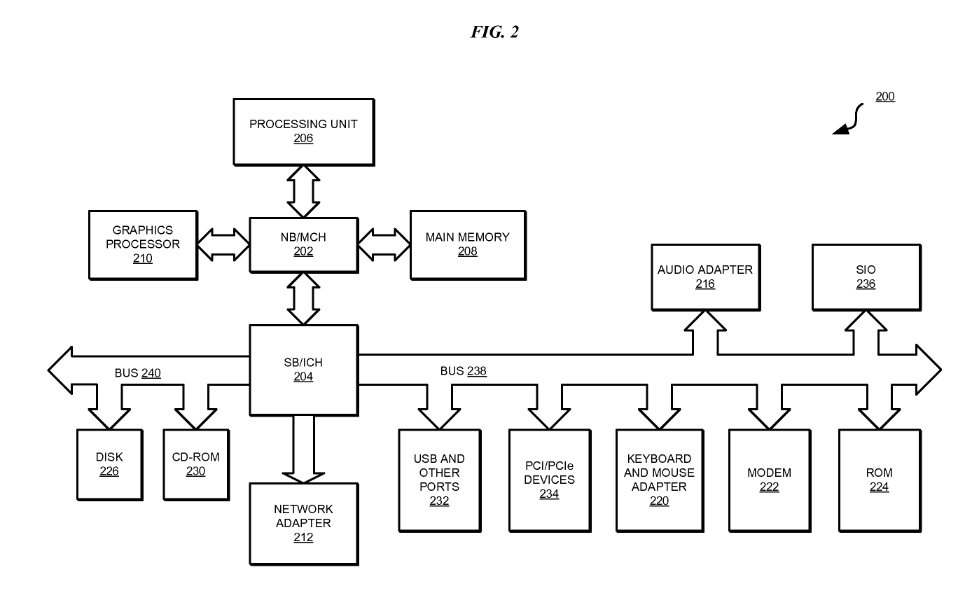

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Any data processing system, such as server 104, may include design tool 105 that may be improved using an embodiment. Design tool 105 may be any suitable software application for designing ICs. Application 107 may be any combination of hardware and software usable for implementing an embodiment of the invention such that the embodiment is usable with design tool 105 for dynamic pin access maximization.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

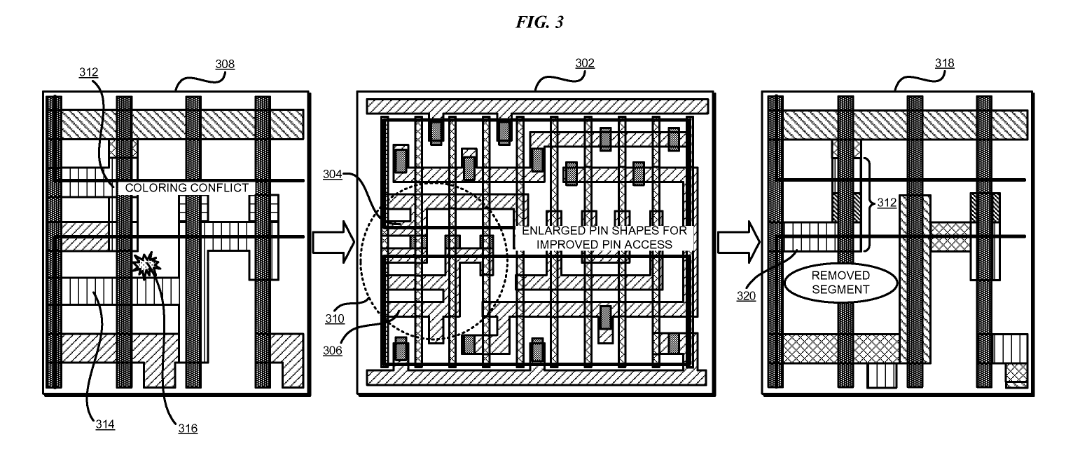

With reference to FIG. 3, this figure depicts a block diagram of an example double-patterned cell including a pin shape with a coloring conflict, in which pin access can be dynamically maximized using an illustrative embodiment.

Cell 302 is an example cell including pin shapes 304 and 306. Cell 308 is a double-patterning solution for portion 310 of cell 302. Segment 312 corresponds to a portion of pin shape 304. Segment 314 corresponds to a portion of pin shape 306.

As shown, segments 312 and 314 are similarly colored. Similarly colored segments 312 and 314 of pin shapes 304 and 306 respectively cause coloring conflict 316 as the spacing between segments 312 and 314 violates the minimum distance restriction.

Cell 318 is a double-patterning solution for the same portion 310 of cell 302 as cell 308, but without coloring conflict 316 of cell 308. Segment 320 corresponds to segment 312 (in the depicted example, as for pin 306, the horizontal middle segment in pin 304 is also removed but not labeled as removed for clarity). A segment of pin shape 306 corresponding to segment 314 has been removed in cell 318. Removing segment 314 may allow for a different coloring option for remainder of pin area 306 and segment 320, as shown.

Removing segment 314 increases the distance between segment 312 and the remainder of pin shape 306, thereby removing conflict 316. However, as the illustrative embodiments recognize, disadvantageously, removing segment 314 from cell 308 to result in the double-patterning solution of cell 318 leaves a reduced area for pin shape 306 that can be used for routing.

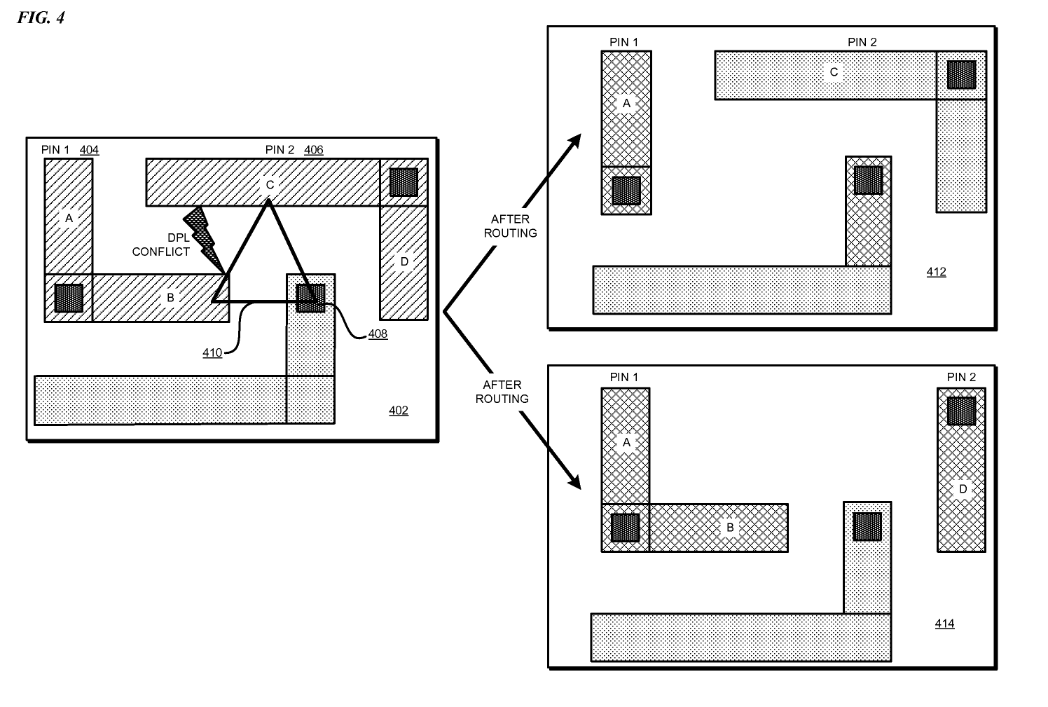

With reference to FIG. 4, this figure depicts a block diagram of maximized pin access with coloring conflict resolution in accordance with an illustrative embodiment. Cell 402 may be a cell or a region of a cell including pin shapes involved in a coloring conflict, such as cell 308 in FIG. 3, which depicts only a part of a cell with conflicting shapes for the clarity of the illustration.

As an example, assume cell 402 includes pin shape 404 labeled “Pin 1”, pin shape 406 labeled “Pin 2”, and another shape, such as for component 408. Illustration 410 shows that these shapes have a coloring conflict that cannot be resolved without shape modification, such as in an odd-cycle, such as when X conflicts with Y, Y conflicts with Z, and Z conflicts with X. A conflict may be resolvable by finding a coloring solution that colors the conflicting shapes differently. A native conflict is not resolvable merely by color selection as there is no coloring solution that can color the set of shapes that have a native conflict. A native conflict can only be resolved by modifying the layout to break odd cycles.

As described in an example earlier, pin shape 404, pin shape 406, and shape for component 408 are in a DPL coloring conflict as shown. Pin shape 404 and pin shape 406 have to colored differently, pin shape 406 and shape for component 408 have to be colored differently, and shape for component 408 and pin shape 404 have to be colored differently.

Pin shape 404 includes segments A and B. Pin shape 406 includes segments C and D.

According to prior art, segment B or segment C could be removed, breaking the odd-cycle and removing the conflict, and the routing could be performed using the modified form of cell 402. However, such pre-routing modification would limit the routing options to only the remaining segments. Consider, for example, that segment B is removed from cell 402. The router then has to perform a routing of a net that connects to pin 1 using only segment A of pin 1. The net connecting to pin 2 can still use both segments C and D of pin 2. Thus, the router is limited to two routing options, namely, segments A-C, or segments A-D. A similar situation arises if segment C is removed prior to routing, and the router is again limited to two routing options A-D, or B-D.

Advantageously, an embodiment leaves segments A, B, C, and D in cell 402 for routing. Now, the router has four routing options, namely, A-C, A-D, B-C, and B-D. Out of these four routing options, only one, B-C, causes the coloring conflict problem as it requires both B and C segments. For the other three solutions, the coloring conflict can be easily resolved by removing one of the conflicting segments.

If the router happens to choose one of the other three routing options where a coloring conflict can be removed by removing one of the conflicting segments, segment B or C can be removed after routing to eliminate the coloring conflict in cell 402. For example, if the router selects segments A-C or A-D for routing, an embodiment removes segment B from cell 402 after routing, resulting in modified cell 412. If the router selects segments A-D or B-D for routing, an embodiment removes segment C from cell 402 after routing, resulting in modified cell 414. As an exception, should the router select the routing option B-C, which includes conflicting segments B and C, an embodiment can remove either segment B or C and re-route the net connecting to the removed segment to resolve the conflict.

The illustrative embodiments recognize and solve the problem of pre-routing conflict resolution, which limits the routing options. In this example, any pre-routing conflict resolution limits the routing options to two, whereas, with post-routing conflict resolution, the router has at least three conflict-free routing options. Thus, an embodiment allows for improved routing as compared to prior art by allowing the routing to proceed with maximized pin shapes, and dynamically removing a conflicting segment of a pin shape only when needed after routing.

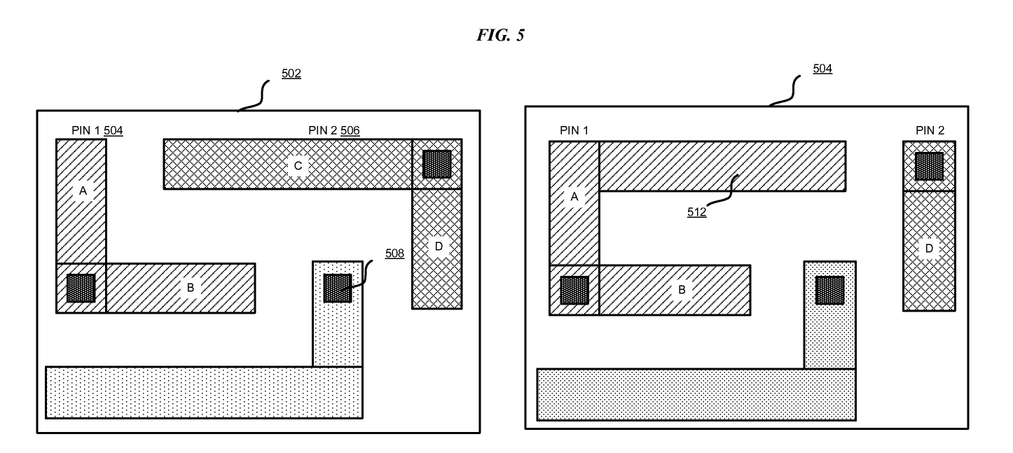

With reference to FIG. 5, this figure depicts a block diagram of maximizing pin access after routing in accordance with an illustrative embodiment. Cell 502, pin shape 504, pin shape 506, shape for component 508 are analogous to cell 402, pin shape 404, pin shape 406, shape for component 408 in FIG. 4, respectively.

Assume that after routing, only segment D of pin 2 is used. In this case, segment C of pin shape 506 (pin 2) can be removed from cell 502, as in cell 414 in FIG. 4. An embodiment further modifies cell 414 of FIG. 4 by expanding pin shape 504 into the space vacated by segment C in a manner such that pin area of pin 1 is maximized.

As shown in cell 510, according to this modification, segment 512 is added to pin shape 504. Thus, an embodiment maximizes the area of pin shape 504, allowing more routing options for pin 1.

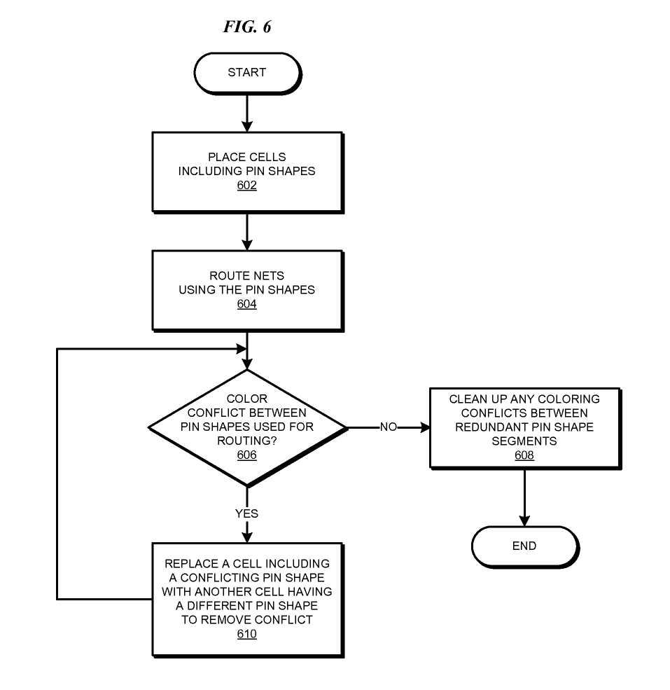

With reference to FIG. 6, this figure depicts a flowchart of a process of dynamically maximizing pin shape for MPL in accordance with an illustrative embodiment. Process 600 can be implemented in a design tool, such as design tool 105 in FIG. 1, or in an application that executes in conjunction with design tool 105, such as application 107 in FIG. 1.

Process 600 begins by placing in an IC design layout, cells including pin shapes (step 602). Process 600 routes the nets to the pin shapes (pins) (step 604). Process 600 determines whether a color conflict exists between the pin shapes, or segments thereof, used for the routing (step 606). If no conflict exists (“No” path of step 606), process 600 cleans up any coloring conflicts between the redundant pin shape segments, such as in cells 412 and 414 in FIG. 4 (step 608). Process 600 ends thereafter. If a coloring conflict exists between the pin shape segments used for the routing (“Yes” path of step 606), process 600 replaces a cell including a conflicting pin shape segment with another version of the cell having a different pin shape, to remove the conflict (step 610). Process 600 returns to step 606 thereafter and ends when no routing includes a coloring conflict.

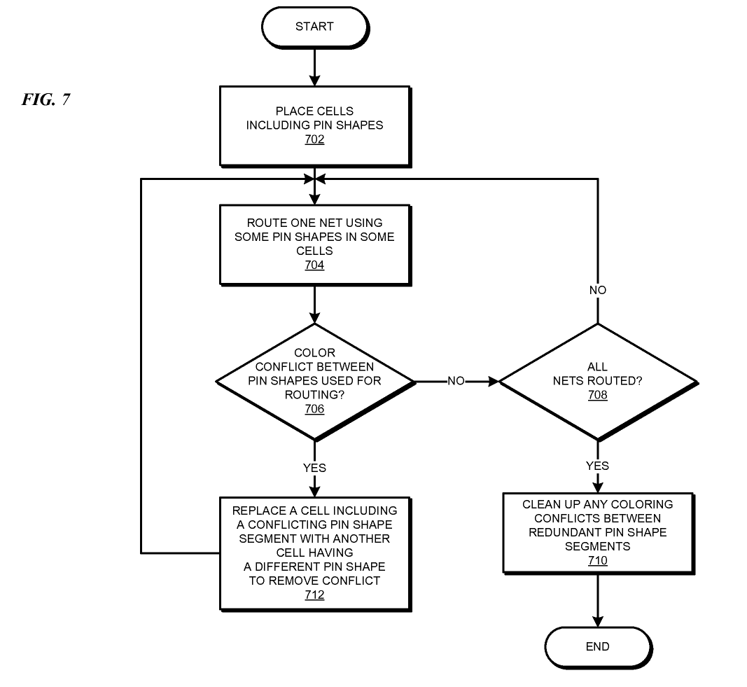

With reference to FIG. 7, this figure depicts a flowchart of another process of dynamically maximizing pin shape for MPL in accordance with an illustrative embodiment. Process 700 can be implemented in a design tool, such as design tool 105 in FIG. 1, or in an application that executes in conjunction with design tool 105, such as application 107 in FIG. 1.

Process 700 begins by placing in an IC design layout, cells including pin shapes (step 702). Process 700 routes one net to some pin shapes in some cells (step 704). Process 700 determines whether a color conflict exists between the pin shapes, or segments thereof, used for the routing (step 706). If no conflict exists (“No” path of step 706), process 700 determines whether all nets have been routed (step 708).

If all nets in the IC design have not been routed (“No” path of step 708), process 700 returns to step 704 and routes another net. If all nets have been routed (“Yes” path of step 708), process 700 may clean up any coloring conflicts between redundant pin shape segments not used in any routing, such as in cells 412 and 414 in FIG. 4 (step 710). Process 700 ends thereafter.

If a coloring conflict exists between the pin shape segments used for the routing (“Yes” path of step 706), process 700 replaces a cell including a conflicting pin shape segment with another version of the cell having a different pin shape, to remove the conflict (step 712). Process 700 returns to step 704 to reroute the net using the other version of the cell.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for dynamic pin access maximization in IC design for MPL. Using an embodiment, conflicts between pin shapes in multi-colored cells can be resolved after placement, allowing the routing to maximize the use of all pin shape segments. An embodiment removes or prunes the conflicting segments after the routing has been selected thereby resolving the conflict between pin shapes.

Furthermore, an embodiment can trim a segment from a pin that has already been routed and increase the area of a pin shape that has not been routed in such a manner that additional segments are available for the unrouted pin to allow additional routing options.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for improving pin access in a design of an integrated circuit (IC) for multi-patterning lithography (MPL), the method comprising:
placing a cell in the IC design, the cell including a pin shape configured to connect a pin of the cell to a semi-conductor component in the IC design, the cell including a coloring conflict due to the pin shape and an other shape in the cell each being colored using a first color for fabricating onto a wafer using MPL;
routing a net to the pin shape without resolving the coloring conflict, wherein the routing routes the net using a first segment of the pin shape; and
modifying the pin shape after routing to resolve the coloring conflict to result in a modified cell.

2. The method of claim 1, further comprising:
detecting that the coloring conflict is caused by a second segment of the pin shape, wherein the routing uses the first segment of the pin shape, and wherein modifying the pin shape after the routing removes the second segment of the pin shape.

3. The method of claim 1, further comprising:
detecting that the coloring conflict is caused by the first segment of the pin shape, wherein the routing uses the conflicting first segment of the pin shape, and wherein the modifying the pin shape after the routing removes the first segment of the other shape; and
rerouting the net using the second segment of the pin shape.

4. The method of claim 1, further comprising:
enlarging, responsive to the modifying, the pin shape by adding a third segment to the pin shape, wherein the third segment of the pin shape is considered in routing a second net.

5. The method of claim 1, wherein the other shape is a second pin shape.

6. The method of claim 1, wherein modifying the pin shape after routing allows the routing to include segments of the pin shape causing the coloring conflict in a set of routing options for routing the net.

7. A computer usable program product comprising a computer usable storage medium including computer usable code for improving pin access in a design of an integrated circuit (IC) for multi-patterning lithography (MPL), the computer usable code comprising:
computer usable code for placing a cell in the IC design, the cell including a pin shape configured to connect a pin of the cell to a semi-conductor component in the IC design, the cell including a coloring conflict due to the pin shape and an other shape in the cell each being colored using a first color for fabricating onto a wafer using MPL;
computer usable code for routing a net to the pin shape without resolving the coloring conflict, wherein the routing routes the net using a first segment of the pin shape; and
computer usable code for modifying the pin shape after routing to resolve the coloring conflict to result in a modified cell.

8. The computer usable program product of claim 7, further comprising:
computer usable code for detecting that the coloring conflict is caused by a second segment of the pin shape, wherein the routing uses the first segment of the pin shape, and wherein modifying the pin shape after the routing removes the second segment of the pin shape.

9. The computer usable program product of claim 7, further comprising:
computer usable code for detecting that the coloring conflict is caused by the first segment of the pin shape, wherein the routing uses the conflicting first segment of the pin shape, and wherein the modifying the pin shape after the routing removes the first segment of the other shape; and
computer usable code for rerouting the net using the second segment of the pin shape.

10. The computer usable program product of claim 7, further comprising:
computer usable code for enlarging, responsive to the modifying, the pin shape by adding a third segment to the pin shape, wherein the third segment of the pin shape is considered in routing a second net.

11. The computer usable program product of claim 7, wherein the other shape is a second pin shape.

12. The computer usable program product of claim 7, wherein modifying the pin shape after routing allows the routing to include segments of the pin shape causing the coloring conflict in a set of routing options for routing the net.

13. The computer usable program product of claim 7, wherein the computer usable code is stored in a computer readable storage medium in a data processing system, and wherein the computer usable code is transferred over a network from a remote data processing system.

14. The computer usable program product of claim 7, wherein the computer usable code is stored in a computer readable storage medium in a server data processing system, and wherein the computer usable code is downloaded over a network to a remote data processing system for use in a computer readable storage medium associated with the remote data processing system.

15. A data processing system for improving pin access in a design of an integrated circuit (IC) for multi-patterning lithography (MPL), the data processing system comprising:
a storage device including a storage medium, wherein the storage device stores computer usable program code; and
a processor, wherein the processor executes the computer usable program code, and wherein the computer usable program code comprises:
computer usable code for placing a cell in the IC design, the cell including a pin shape configured to connect a pin of the cell to a semi-conductor component in the IC design, the cell including a coloring conflict due to the pin shape and an other shape in the cell each being colored using a first color for fabricating onto a wafer using MPL;
computer usable code for routing a net to the pin shape without resolving the coloring conflict, wherein the routing routes the net using a first segment of the pin shape; and
computer usable code for modifying the pin shape after routing to resolve the coloring conflict to result in a modified cell.

16. The data processing system of claim 15, further comprising:
computer usable code for detecting that the coloring conflict is caused by a second segment of the pin shape, wherein the routing uses the first segment of the pin shape, and wherein modifying the pin shape after the routing removes the second segment of the pin shape.

17. The data processing system of claim 15, further comprising:
computer usable code for detecting that the coloring conflict is caused by the first segment of the pin shape, wherein the routing uses the conflicting first segment of the pin shape, and wherein the modifying the pin shape after the routing removes the first segment of the other shape; and
computer usable code for rerouting the net using the second segment of the pin shape.

18. The data processing system of claim 15, further comprising:
computer usable code for enlarging, responsive to the modifying, the pin shape by adding a third segment to the pin shape, wherein the third segment of the pin shape is considered in routing a second net.

19. The data processing system of claim 15, wherein the other shape is a second pin shape.

20. The data processing system of claim 15, wherein modifying the pin shape after routing allows the routing to include segments of the pin shape causing the coloring conflict in a set of routing options for routing the net.
